(19) United States
(12) Patent Application Publication
(10) Pub. No.: US 2025/0008891 A1
(43) Pub. Date: Jan. 9, 2025

(54) SOAK-AWAY

(71) Applicant: TAI-MING HUANG, Fenyuan Township (TW)

(72) Inventor: TAI-MING HUANG, Fenyuan Township (TW)

(21) Appl. No.: 18/218,514

(22) Filed: Jul. 5, 2023

(51) Int. Cl. A01G 25/06

(52) U.S. Cl. CPC A01G 25/06; A01G 25/02

(57) ABSTRACT

A soak-away includes a soak-away sleeve for wrapping a hose. The hose allows liquid to travel in and along it. The hose includes relatively large apertures and relatively thick portions. The relatively large apertures slantly extend through a wall of the hose. The relatively thick portions of the hose around the relatively large apertures, respectively. The soak-away sleeve includes relatively small apertures. The liquid is allowed to go out of the soak-away sleeve through the relatively small apertures.

### BACKGROUND OF INVENTION

### 1. Field of Invention

The present invention relates to irrigation and, more particularly, to a soak-away.

### 2. Related Prior Art

Soak-aways are used for even irrigation. A conventional soak-away includes a hose and a soak-away sleeve for wrapping the hose. The hose includes relatively large apertures and the soak-away sleeve is fabric including relatively small apertures.

In use, liquid is introduced into the hose at a predetermined value of pressure. The liquid goes out of the hose through the relatively large apertures as the former travels in and along the latter because of the pressure. Then, the liquid goes out of the soak-away sleeve via the relatively small apertures. Thus, soil around the soak-away is soaked evenly.

There however problems with the use of the conventional soak-away. Firstly, the relatively large apertures extend in perpendicular to an axis of the hose. Hence, the liquid goes out of the hose via the relatively large apertures faster than expected.

Secondly, the relatively large apertures can be clogged if they are made smaller.

Thirdly, the thickness of the hose is constant throughout the axis. The portions of the hose around the relatively large apertures are weak and hence can be worn away so that the relatively large apertures are enlarged. Hence, the liquid goes out of the hose even faster than expected.

Fourthly, in practice, the value of pressure in an upstream section of the hose is higher than the value of pressure in a downstream section of the hose. Hence, a flow rate out of the upstream section of the hose is higher than a flow rate out of the downstream section of the hose. This problem gets even worse when the relatively large apertures are enlarged undesirably.

Fifthly, the portions of the hose around the relatively large apertures are weak. The hose can be burst from the portions of the hose around the relatively large apertures. The irrigation is not even.

Sixthly, the relatively small apertures are of one size. The irrigation is adjustable to satisfy various needs.

The present invention is therefore intended to obviate or at least alleviate the problems encountered in the prior art.

### SUMMARY OF INVENTION

It is the primary objective of the present invention to provide a reliable soak-away.

To achieve the foregoing objective, the soak-away includes a soak-away sleeve for wrapping a hose. The hose allows liquid to travel in and along it. The hose includes relatively large apertures and relatively thick portions. The relatively large apertures slantly extend through a wall of the hose. Each of the relatively thick portions of the hose arounds around a corresponding one of the relatively large apertures. The soak-away sleeve includes relatively small apertures. The liquid is allowed to go out of the soak-away sleeve through the relatively small apertures.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a soak-away according to the preferred embodiment of the present invention;

FIG. 2 is an enlarged cross-sectional view of the soak-away shown in FIG. 1;

FIG. 3 is a side view of the soak-away shown in FIG. 2;

FIG. 4 is an enlarged view of a portion of the soak-away depicted in FIG. 3; and

FIG. 5 is an enlarged partial view of another portion of the soak-away shown in FIG. 3.

### DETAILED DESCRIPTION OF PREFERRED EMBODIMENT

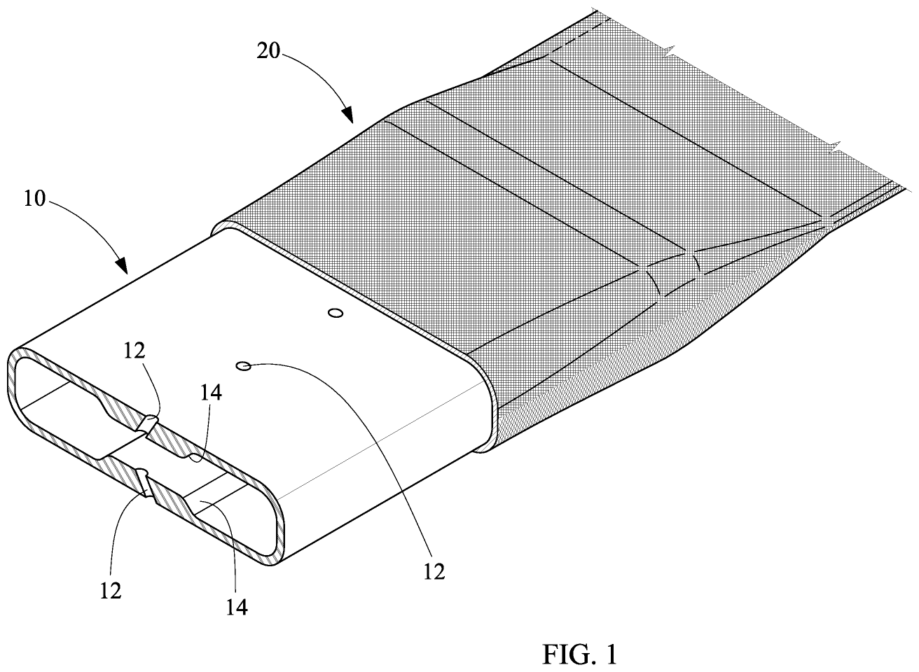

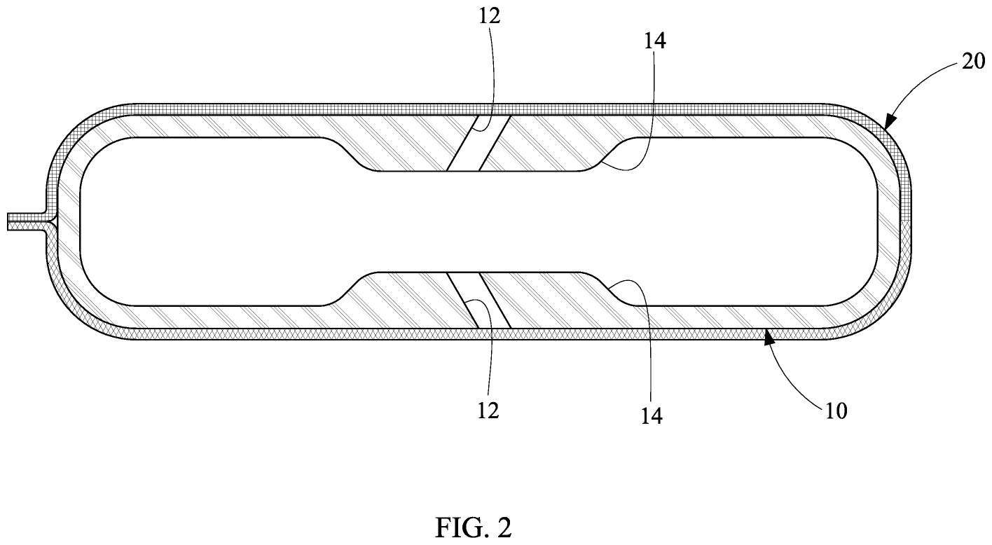

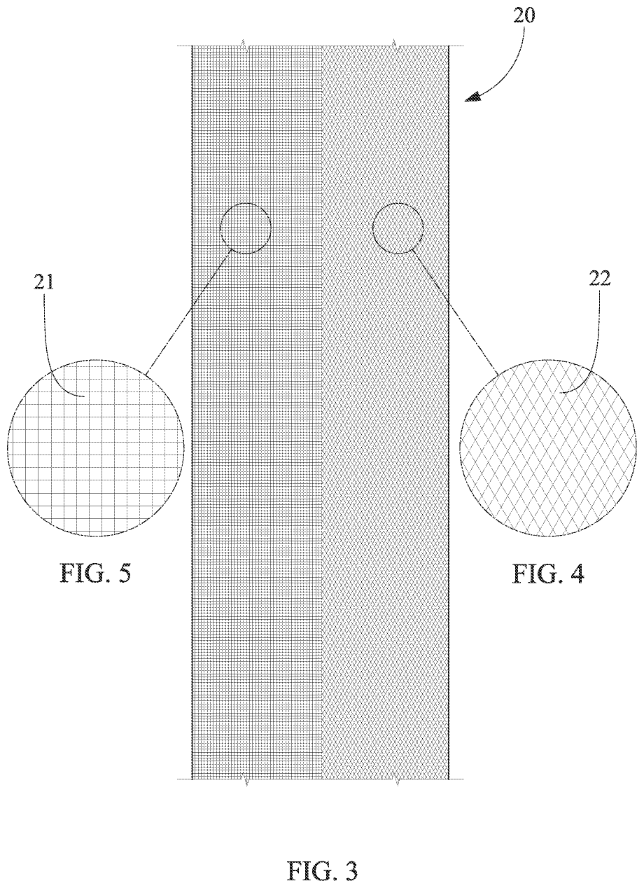

Referring to FIGS. 1 to 5, a soak-away includes a hose 10 and a soak-away sleeve 20 according to the preferred embodiment of the present invention. Liquid is allowed to travel in and along the hose 10. The hose 10 includes relatively large apertures 12 and relatively thick portions 14. Each of the relatively large apertures 12 is made in a corresponding one of the relatively thick portions 14.

The relatively large apertures 12 slantly extend through a wall of the hose 10. That is, an axis of each of the relatively large apertures 12 is not in perpendicular or parallel to an axis of the hose 10.

Each of the relatively thick portions 14 of the hose 10 extends around the corresponding one of the relatively large apertures 12. The relatively thick portions prevent the relatively large apertures 12 from enlargement. The relatively thick portions 14 of the hose 10 can be formed on an internal and/or external face of the hose 10.

Preferably, the relatively thick portions 14 of the hose 10 are separated from one another. Alternatively, the relatively thick portions 14 of the hose 10 are arranged in series. The relatively thick portions 14 of the hose 10 in each of the series are connected to one another. That is, each of the series of relatively thick portions 14 of the hose 10 becomes a ridge.

The soak-away sleeve 20 wraps the hose 10. The soak-away sleeve 20 includes relatively small apertures 21. The soak-away sleeve 20 is a woven element made by twill weave or cross weave. The cross weave renders the relatively small apertures 21 rectangular (FIG. 5). The twill weave renders the relatively small apertures 22 rhombus (FIG. 4). The size of the rectangular relatively small apertures 21 is smaller than the size of the rhombus relatively small apertures 22.

In operation, the liquid travels in and along the hose 10. During the travel, the liquid goes out of the hose 10 through the relatively large apertures 12. Then, the liquid goes out of the soak-away sleeve 20 through the relatively small apertures 21. Thus, soil around is the soak-away is evenly irrigated.

The axes of the relatively large apertures 12 are slant relative to the axis of the hose 10. Thus, the liquid travels for an elongated distance via the wall of the hose 10. The liquid is not likely to go out of the hose 10 faster than expected.

Furthermore, the relatively small apertures 21 are in various shapes and sizes the soak-away sleeve 20. The soak-away satisfies various needs for irrigation.

The relatively thick portions 14 of the hose 10 provide the relatively large apertures 12 from enlargement. Moreover, the relatively thick portions 14 of the hose 10 avoid bursting of the hose 10 from the relatively large apertures 12.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A soak-away comprising:
a hose (10) for allowing liquid to travel in and along it, wherein the hose (10) comprises relatively large apertures (12) slantly extending through a wall of the hose (10) and relatively thick portions (14) around the relatively large apertures (12), respectively; and
a soak-away sleeve (20) for wrapping the hose (10), wherein the soak-away sleeve (20) comprises relatively small apertures (21, 22) through which the liquid is allowed to go out of the soak-away sleeve (20).

2. The soak-away according to claim 1, wherein the relatively thick portions (14) of the hose (10) are formed on an external face of the hose (10).

3. The soak-away according to claim 1, wherein the relatively thick portions (14) of the hose (10) are formed on an internal face of the hose (10).

4. The soak-away according to claim 1, wherein the soak-away sleeve (20) is a woven element made by twill weave.

5. The soak-away according to claim 4, wherein the relatively small apertures (21) are rhombus.

6. The soak-away according to claim 1, wherein the soak-away sleeve (20) is a woven element made by cross weave.

7. The soak-away according to claim 6, wherein the relatively small apertures (21) are rectangular.

8. The soak-away according to claim 1, wherein the soak-away sleeve (20) is a woven element made by twill weave and cross weave.

9. The soak-away according to claim 8, wherein some of the relatively small apertures (21) caused by the twill weave are smaller than some others of the relatively small apertures (22+) made by the cross weave.

10. The soak-away according to claim 1, wherein each of the relatively large apertures (12) extends along an axis not in perpendicular to an axis of the hose (10).
